(19) United States
(12) Patent Application Publication
(10) Pub. No.: US 2005/0278277 A1
(43) Pub. Date: Dec. 15, 2005

(54) Method and apparatus for propogating tables while preserving foreign key integrity

(75) Inventors: Randolph Michael Forlenza, Austin, TX (US); Raghuraman Kalyanaraman, Austin, TX (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/855,736

(22) Filed: May 27, 2004

(51) Int. Cl. G06F 7/00

(52) U.S. Cl. 707/1

(57) ABSTRACT

The invention disclosed is a method and apparatus for propagating database tables while preserving foreign key integrity. The invention comprises an improved method of storing subscription sets that enables a user to assign a rank to a subscription set and to each member of the set, and an improved database propagation program that uses the ranks to determine the order in which to propagate database tables. In the preferred embodiment, subscription sets are stored in a subscription table and subscription members are stored in a member table. The preferred embodiment database propagation program further comprises a CAPTURE program and an APPLY program, wherein CAPTURE monitors a database for changes and APPLY propagates data from member tables in the subscription sets.

### BACKGROUND OF THE INVENTION

The invention disclosed herein is generally directed to database maintenance in a computer or digital processing system, and in particular, to a method of propagating tables that allows foreign key integrity to be preserved.

In general, a database is any collection of information organized for rapid search and retrieval. A database stored in a computer-readable medium commonly is modeled as a collection of one or more tables. Each table, in turn, is modeled as a collection of one or more records (referred to commonly as a “row”), and each record as a collection of one or more fields (referred to commonly as a “column”). In a conventional table, all records comprise the same number and type of fields, and in the same order. A relational database consists of tables that are “related” to each other through common fields. The most common way to establish a relationship between two tables is to include one or more fields in each table that hold “key” information. A “primary key” field uniquely identifies a record, and commonly is just a number unrelated to other data in the record. A “foreign key” field is an identifier in a record that establishes a relationship with a primary key in another table. For example, employee records might have an “employee” table containing a “department_id” field that references data located in a “department” table's “dept_id” field. In this example, the dept_id field uniquely identifies each department, while the department_id field identifies the department in which an employee works. Thus, in this example, dept_id would be a primary key, and department_id would be the foreign key that establishes the relationship between the employee table and the department table. The integrity of the table relationship depends on the foreign key referencing a valid primary key. Most modern database management systems allow users to designate foreign key fields when tables are created, and subsequently reject operations that would result in an invalid foreign key reference. Thus, all foreign key values must have equivalent primary key values that already exist in the other table.

As is well known in the art, it is sometimes advantageous to replicate databases on other computers or servers, or even on the same computer. It is common, though, for a database to hold thousands of tables and millions of records, and replicating these databases can be a difficult and cumbersome task. Several software tools exist in the art to assist a database administrator with the task of replicating (also called “propagating”) databases among servers, including DpropR—a database utility developed by IBM. DpropR uses “subscription sets” to determine which tables should be propagated, and to which servers. A subscription set generally comprises a list of tables that a database administrator or user treats as a single unit for purposes of database propagation. A database administrator specifies in advance what tables are included in a subscription set, and can create more than one subscription set if needed or desired.

Subscription sets are themselves typically stored in relational tables: a “subscription” table and a “member” table. Example prior art subscription and member tables ate depicted in FIGS. 1 and 2, respectively, and described below.

FIG. 1 illustrates a prior art subscription table. A prior art subscription table comprises records identifying a subscription set, the server having the source database to be copied, and the target database to which the source database should be copied. These fields are labeled in FIG. 1 as SET_NAME, SOURCE_SERVER, and TARGET_SERVER, respectively. The subscription set may also contain other useful information, such as a value indicating the last time the source database was copied, and a value indicating a frequency for copying the source table. The illustrative values in FIG. 1 indicate that four subscription sets exist and are named: payroll, orders, inventory, and sales_emp.

FIG. 2 illustrates a prior art member table. A prior art member table comprises records identifying a source table, the subscription set to which the source table belongs, and the name of the target table to which the source table should be copied. These fields are labeled in FIG. 2 as SOURCE_TABLE, SET_NAME, and TARGET_TABLE, respectively. The illustrative values in FIG. 2 indicate that there are two source table members in the “payroll” subscription set, and that the name of these tables on the source server are “employees” and “departments.” Similarly, there are three source table members in the “inventory” subscription set, three members in the “orders” subscription set, and two members in the “sales_emp” subscription. Each subscription set identified in the member table must have a corresponding record in the subscription table. Note, though, that a source table can appear in more than one subscription set.

Currently, however, the database administrator cannot control effectively the order in which a database propagation utility propagates subscription sets (and the tables in the sets). For example, DpropR propagates tables and subscription sets randomly. Consequently, DpropR may attempt to propagate a table containing a foreign key before propagating the table containing the primary key on which the foreign key depends, and the underlying database management system may reject the DpropR operation. For example, FIG. 2 illustrates a “payroll” subscription set containing the “employees” table and the “departments” table. If, as in the hypothetical discussed above, the “employees” table contains foreign keys that refer to fields in the “departments” table and DpropR attempts to propagate the employees table before propagating the departments table, then the employees table would contain values in the department_id fields that reference non-existent values, and the operation would fail. Thus, a database administrator needs a method for preventing DpropR, or other database propagation utilities, from propagating a table containing a foreign key before propagating the table in which the foreign key resides.

U.S. Pat. No. 5,819,254 issued to Kawai provides one method for controlling the order in which relational tables are copied from one database to another. Kawai discloses a computer program with a user interface that requires a user to select manually which field in a source database is to be moved into which field in a corresponding destination database. Kawai's computer program stores the list of tables in random order and then sorts the list so that the data is written into the “least dependent table” first, followed by those tables that contain foreign keys to the least dependent table. Kawai defines the “least dependent table” as the table that does not contain any foreign keys.

Kawai's method, however, is designed primarily for home users and relatively small databases. Kawai provides little flexibility for specifying a particular order for copying tables and requires user interaction for every copy operation. Thus, while Kawai's method may be useful for occasional transfers of small databases, it is not a practical solution for routine propagation of large relational databases. For routine propagation of large relational databases, database administrators still need a means to control the order in which a database utility, such as DpropR, propagates related tables, so that they can preserve foreign key integrity during propagation.

### SUMMARY OF THE INVENTION

The invention disclosed herein comprises a method and apparatus for propagating relational database tables that allow a database administrator to control the order of propagation, and thereby preserve foreign key integrity as needed. More particularly, the invention comprises an improved method of storing subscription sets that enables an administrator or other user to assign a rank to each subscription set and to each table within a subscription set, and an improved database propagation program that uses the ranks assigned by the administrator or other user to determine the order in which to propagate database tables.

In the preferred embodiment, at least one subscription set is stored in an improved subscription table, and members of a subscription set are stored in an improved member table. The improved subscription table comprises a field for designating a set name, a field for designating the source server, a field for designating a target server, and a new field for specifying the subscription set rank. The improved member table comprises a field for specifying the subscription set in which a source table is a member, a field for designating the source table, a field for designating a target table, and a new field for specifying the rank of the source table within the subscription set in which the source table is a member. The preferred embodiment of the database propagation program further comprises a CAPTURE program and an APPLY program, wherein CAPTURE monitors a database for changes and APPLY propagates data from source tables of the subscription sets.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a prior art subscription table;

FIG. 2 is an illustration of a prior art member table;

FIG. 3 is a depiction of a typical networked computing environment in which a person of skill in the art could implement the present invention;

FIG. 4 represents the memory configuration of a typical computing workstation using the present invention;

FIG. 5 illustrates a subscription table as used in the present invention;

FIG. 6 illustrates a member table as used in the present invention; and

FIG. 7 illustrates the operation of the inventive database propagation program.

### DETAILED DESCRIPTION OF THE PREFERRED EMBODIMENT

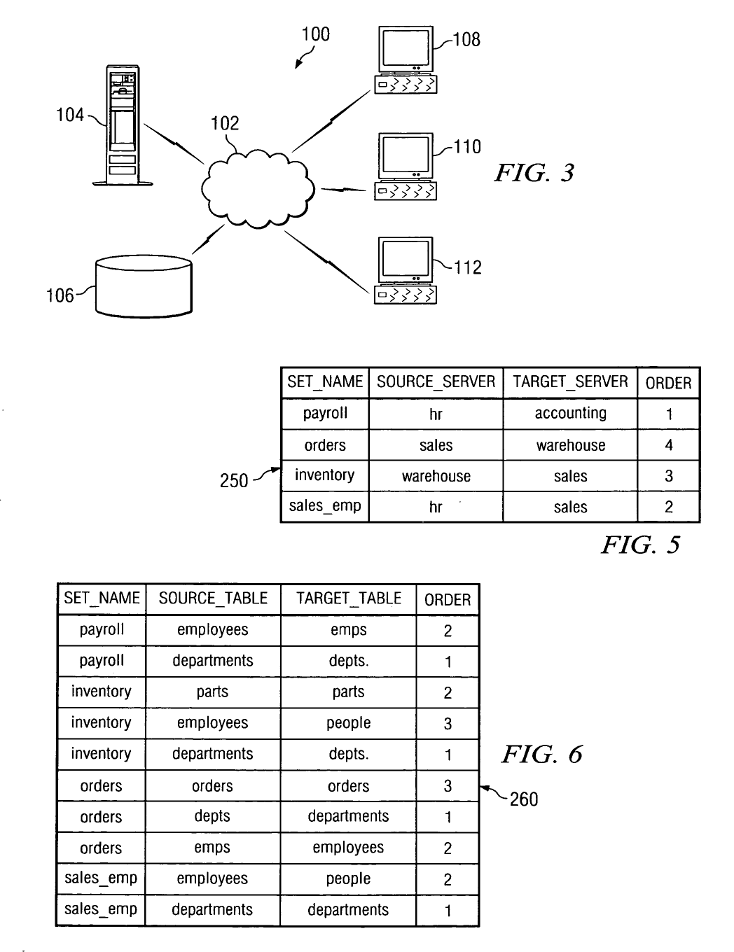

FIG. 3 is an illustration of computer network 100 associated with the present invention. Computer network 100 comprises local workstation 108 electrically coupled to network connection 102. Local workstation 108 is coupled electrically to remote workstation 110 and remote workstation 112 via network connection 102. Local workstation 108 also is coupled electrically to server 104 and persistent storage 106 via network connection 102. Network connection 102 may be a simplified local area network (LAN) or may be a larger network such as a wide area network (WAN) or the Internet. Furthermore, computer network 100 depicted in FIG. 3 is intended as a representation of a possible operating network that may contain the present invention and is not meant as an architectural limitation.

The internal configuration of a computer, including connection and orientation of the processor, memory, and input/output devices, is well known in the art. The present invention can be embodied in a computer program. Referring to FIG. 4, the present invention is implemented in database propagation program (DPP) 220, which resides in memory 200. DPP 220 comprises CAPTURE 230 and APPLY 240. DPP 220 described herein can be stored within memory 200 of any workstation or server depicted in FIG. 4. Alternatively, DPP 220 can be stored in an external storage device such as persistent storage 106, or a removable disk such as a CD-ROM (not pictured). Memory 200 is only illustrative of memory within one of the machines depicted in FIG. 4 and is not meant as a limitation. Memory 200 also contains resource data 210. Resource data 210 comprises subscription table 250 and member table 260. The present invention may interface with resource data 210 through memory 200.

In alternative embodiments, DPP 220 and its components can be stored in the memory of other computers. Storing DPP 220 in the memory of other computers allows the processor workload to be distributed across a plurality of processors instead of a single processor. Further configurations of DPP 220 across various multiple memories and processors are known by persons skilled in the art.

As described in detail below, DPP 220 uses subscription sets to determine the order in which to propagate tables. As used in this disclosure, a “subscription set” is any listing of database tables to be copied, in which the database tables are grouped in larger sets. In the preferred embodiment, a subscription set comprises a record in subscription table 250 and a record in member table 260. FIG. 5 illustrates the preferred embodiment of a subscription table, and FIG. 6 illustrates the preferred embodiment of a member table.

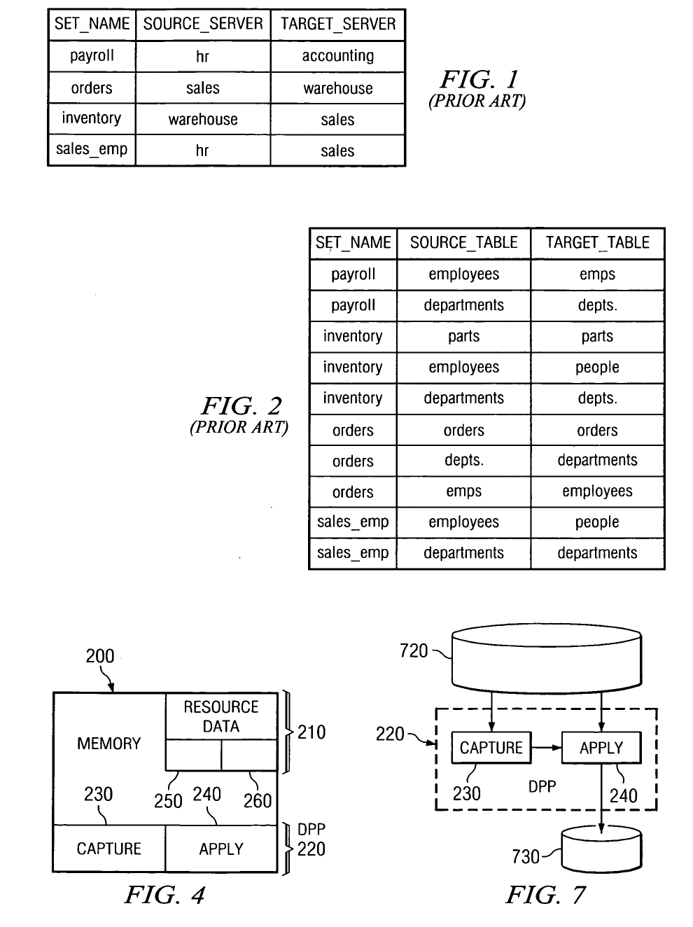

The difference between a prior art subscription table (FIG. 1) and the table illustrated in FIG. 5 is the field labeled “ORDER.” In the preferred embodiment, a database administrator assigns a subscription rank to each record in subscription table 250 and stores this rank in the ORDER field. The “subscription rank” indicates the order, relative to other records in subscription table 250, in which DPP 220 should propagate the subscription set identified by the record. In the preferred embodiment, the ORDER field is an integer value, but a person of skill in the art will appreciate that other data types can be used to indicate relative order, including without limitation alphabetical characters and decimal numbers. The database administrator cannot assign the same rank to more than one record in subscription table 250.

Similarly, the difference between a prior art member table (FIG. 2) and the member table illustrated in FIG. 6 is the field labeled “ORDER.” In the preferred embodiment, a database administrator determines which tables should be propagated and assigns the tables to a subscription set identified in subscription table 250. The subscription set to which the database administrator assigns the tables is recorded in the SET_NAME field, as illustrated in FIG. 6. As used herein, a “source table” refers to a database table that has been assigned to a subscription set. In FIG. 6, source table members are stored in the SOURCE_TABLE field. The database administrator also assigns a member rank to each record in member table 260 and stores this rank in the ORDER field. The “member rank” of a record in member table 260 indicates the order, relative to other records belonging to the same subscription set, in which DPP 220 should propagate the source table identified by the record. Again, the ORDER field in member table 260 is an integer value in the preferred embodiment, but a person of skill in the art will appreciate that other data types can be used to indicate relative order. The database administrator cannot assign the same rank to more than one record within the same subscription set (as identified in the SET_NAME field) in member table 260.

Once the database administrator has configured subscription table 250 and member table 260 and assigned a rank to each subscription set and each source table member in each subscription set, DPP 220 sorts the ORDER data by rank to generate a propagation sequence. As used herein, a “propagation sequence” is any ordered list of source tables to be copied. The propagation sequence ultimately dictates the order that DPP 220 copies tables from a source server to a target server. In the preferred embodiment, DPP 220 first sorts the subscription sets by subscription rank, and then sorts the source tables by member rank within each subscription set. It should be noted that the particular sorting method employed is not critical to the operation of DPP 220, and a person of skill in the art will appreciate that sorting methods are widely available in many different forms. A person of skill in the art will further appreciate that any program can execute the sorting operation, including the underlying database management system, without affecting the novel aspects of the present invention.

After DPP 220 generates a propagation sequence, APPLY 240 then propagates the source tables in the order that the tables appear in the propagation sequence. In the preferred embodiment, the source tables are copied from one server to another, referred to herein as a “source server” and a “target server” respectively. A person of skill in the art, though, will appreciate that the technology described herein also may be applied to many other configurations, including without limitation copying from one table to another within the same server.

In the preferred embodiment, DPP 220 also comprises CAPTURE 230 that monitors source server 720 for changes. Responsive to detecting a change, APPLY 240 copies data from source server 720 to target server 730, as illustrated in FIG. 7. A person of ordinary skill in the art will appreciate that there are many different methods for monitoring and detecting changes to a database. Generally, though, a database server creates a log file that records database activity, and the preferred embodiment of CAPTURE 230 monitors the log file for changes. Thus, when the log file indicates a change in a database, CAPTURE 230 captures the data and APPLY 240, when executed by DPP 220, copies the data to the target substantially as described above.

It should be noted that the invention described above does not address the issue of propagating tables that refer to each other, through foreign keys and primary keys, in a circular order. For example, if table C has a foreign key referring to B, B has a foreign key referring to A, and A has a foreign key referring to C, then there is no way to designate a rank or otherwise give priority to table A or to table C.

A person of skill in the art will appreciate that various modifications and changes may be made in the preferred embodiment of the present invention without departing from its true spirit. The preceding description is for illustrative purposes only and should not be construed in a limiting sense. The present invention encompasses all embodiments equivalent to those illustrated in the drawings and described in the specification. The scope of the invention should be limited only by the language of the following claims.

1. A programmable apparatus for propagating database tables having one or more foreign keys comprising:
a processor;
a memory;
one or more subscription sets in the memory;
a propagation sequence in the memory;
each subscription set comprising one or more source table members, each source table member having an associated target table; and
a database propagator program in the memory for directing the processor to
load each subscription set into the memory,
load the propagation sequence into the memory, and
copy each source table member to the source table member's associated target table, according to the propagation sequence;
whereby the integrity of the foreign keys is preserved.

2. The programmable apparatus of claim 1 wherein:
each subscription set further comprises a subscription rank; and
the propagation sequence comprises a series of subscription sets sorted by subscription rank.

3. The programmable apparatus of claim 1 wherein:
each subscription set further comprises a subscription rank;
each source table of each subscription set further has an associated member rank; and
the propagation sequence comprises a series of source table members first sorted by subscription rank and second sorted by member rank within each subscription rank.

4. The programmable apparatus of claim 1 wherein:
the subscription sets are stored in a propagation database;
the propagation database comprising
a subscription table and
a member table;
the subscription table comprising
a subscription name field identifying a subscription set and
a subscription order field designating a subscription rank for each subscription name field;
the member table comprising
a source table field identifying a source table member,
a subscription name field identifying the subscription set to which the source table member belongs,
a target table field designating a target table for each source table field, and
a member order field designating a member rank for the source table field; and
the propagation sequence comprises a series of subscription sets sorted by subscription rank.

5. The programmable apparatus of claim 4 wherein:
the series of subscription sets within the propagation sequence comprises a series of source tables sorted by member rank.

6. The programmable apparatus of claim 1 further comprising:
a database monitor program in the memory for directing the processor to
detect changes in source table members and
responsive to detecting changes in any source table member, call the database propagator program.

7. A programmable apparatus for propagating database tables comprising:
a processor;
a memory;
means for storing one or more subscription sets;
each subscription set comprising one or more source table members, each source table member having an associated target table;
means for causing the processor to load each subscription set into the memory;
means for causing the processor to generate a propagation sequence;
means for causing the processor to load the propagation sequence into the memory; and
means for directing the processor to propagate each source table member to the source table member's associated target table, according to the propagation sequence.

8. The programmable apparatus of claim 7 further comprising means for detecting changes in source table members and, responsive to detecting changes in source table members, causing the processor to load each subscription set into the memory, to generate a propagation sequence, to load the propagation sequence into the memory, and to propagate each source table member.

9. A computer-readable memory for causing a computer to propagate database tables having one or more foreign keys, wherein the computer-readable memory comprises:
a computer-readable storage medium;
one or more subscription sets stored in the computer-readable storage medium;
a propagation sequence stored in the computer-readable storage medium;
each subscription set comprising one or more source table members, each source table member having an associated target table; and
a database propagator program stored in the storage medium, wherein the database propagator program so stored in the storage medium causes the computer to
load each subscription set into a memory,
load the propagation sequence into a memory, and
copy each source table member to the source table member's associated target table, according to the propagation sequence;
whereby the integrity of the foreign keys is preserved.

10. The computer-readable memory of claim 9 wherein:
each subscription set further comprises a subscription rank and
the propagation sequence comprises a series of subscription sets sorted by subscription rank.

11. The computer-readable memory of claim 9 wherein:
each subscription set further comprises a subscription rank;
each source table member of each subscription set further has an associated member rank; and
the propagation sequence comprises a series of source table members first sorted by subscription rank and second sorted by member rank within each subscription rank.

12. The computer-readable memory of claim 9 wherein:
the subscription sets are stored in a propagation database in the computer-readable storage medium;
the propagation database comprising
a subscription table and
a member table;
the subscription table comprising
a subscription name field identifying a subscription set and
a subscription order field designating a subscription rank for the subscription name field;
the member table comprising
a source table field identifying a source table member,
a subscription name field identifying the subscription set to which the source table member belongs,
a target table field designating a target table for the source table field, and
a member order field designating a member rank for the source table field; and
the propagation sequence comprises a series of subscription sets sorted by subscription rank.

13. The computer-readable memory of claim 12 wherein:
the series of subscription sets within the propagation sequence comprises a series of source tables sorted by member rank.

14. The computer-readable memory of claim 9 further comprising:
a database monitor program stored in the storage medium, wherein the database monitor program so stored in the storage medium cause the computer to
detect changes in source table members and
responsive to detecting changes in any source table member, call the database propagator program.

15. A method for propagating database tables having one or more foreign keys comprising:
loading one or more subscription sets into a memory;
wherein each subscription set comprises source table members, each source table member having an associated target table;
loading a propagation sequence into the memory; and
copying source table members to target tables according to the propagation sequence;
whereby the integrity of the foreign keys is preserved.

16. The method of claim 15 further comprising the step of:
before loading the propagation sequence into the memory, building the propagation sequence by ordering source table members according to subscription rank.

17. The method of claim 15 further comprising the step of:
before loading the propagation sequence into the memory, building the propagation sequence by ordering source table members according to subscription rank, and then according to member rank.
